(19) United States
(12) Patent Application Publication
(10) Pub. No.: US 2003/0141829 A1
(43) Pub. Date: Jul. 31, 2003

(54) Current equalizer assembly for LCD backlight panel

(76) Inventors: Shan-Ho Yu, Hsi-Chih City (TW); Hua-Ming Chen, Taipei (TW); Jian-Yi Wu, Taoyuan City (TW); Chi-Hua Tu, Taipei Hsien (TW); Kevin Wang, Taipei (TW)

Correspondence Address: SUPREME PATENT SERVICES, POST OFFICE BOX 2339, SARATOGA, CA, 95070, US

(21) Appl. No.: 10/062,874

(22) Filed: Jan. 31, 2002

(51) Int. Cl. H05B 37/00

(52) U.S. Cl. 315/276; 315/244

(57) ABSTRACT

A current equalizer assembly for LCD backlight panel comprises at least a differential current choke and at least a capacitor. The capacitor is arranged striding on a terminal (B) at a primary coil and on a terminal (D) at a secondary coil of the differential current choke so as to equalize the current flowing through every cold cathode fluorescent lamp (CCFL) connected to the differential current choke and the lightness thereof accordingly. Moreover, the capacitance of the stridden capacitor is replaceable by the intrinsic stray capacitance when the inductance of the differential current choke is properly selected.

### FIELD OF THE INVENTION

This invention relates generally to a control circuit applied to cold cathode fluorescent lamps (CCFLs) of liquid crystal display (LCD), more particularly, it relates to a current equalizer assembly for balancing and equalizing a current flowing through the CCFLs.

### BACKGROUND OF THE INVENTION

A known backlight panel of LCD is usually provided at least with a cold cathode florescent lamp (CCFL) as shown in FIG. 1, which reveals a conventional control circuit, which includes a CCFL 101 and a cascade capacitor 111, working for a single CCFL apparatus. A control circuit for control of two CCFLs includes a CCFL 103, 105 and a cascade capacitor 113, 115.

Because the capacitive impedance of the capacitor 111, 113, 115 is far larger than the impedance of the CCFL 101, 103, 105, hence a current flowing through the CCFLs might be considered uniform reluctantly but still far to equality that shows a perceivable difference in lightness among the CCFLs.

### SUMMARY OF THE INVENTION

The primary object of this invention is to provide a current equalizer assembly for LCD backlight panel that can equalize a current flowing through different cold cathode fluorescent lamps (CCFLs) so that a uniform lightness in the backlight panel of LCD is obtainable.

In order to realize abovesaid object, a current equalizer assembly of this invention applied to the backlight panel of LCD comprises: at least a differential current choke and at least a capacitor, in which the capacitor is arranged striding on a terminal (B) at a primary coil and a terminal (D) at a secondary coil of a differential current choke such that a current flowing through the CCFLs can be well balanced in lightness all over the backlight panel of LCD.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows a conventional control circuit having a single cold cathode fluorescent lamp (CCFL);

FIG. 2 shows a conventional control circuit with two CCFLs;

FIG. 3 shows a first embodiment of this invention;

FIG. 4 shows a second embodiment of this invention;

FIG. 5 shows a third embodiment of this invention;

FIG. 6A shows the structure of a current equalizer of this invention; and

FIG. 6B shows an equivalent circuit of FIG. 6A.

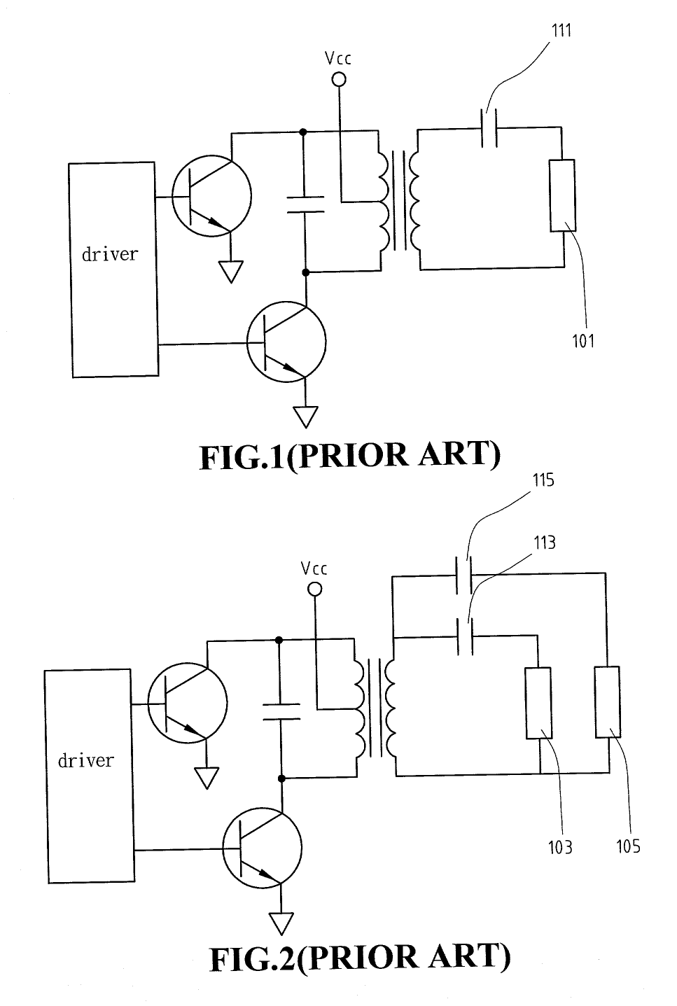

### DETAILED DESCRIPTION OF THE INVENTION

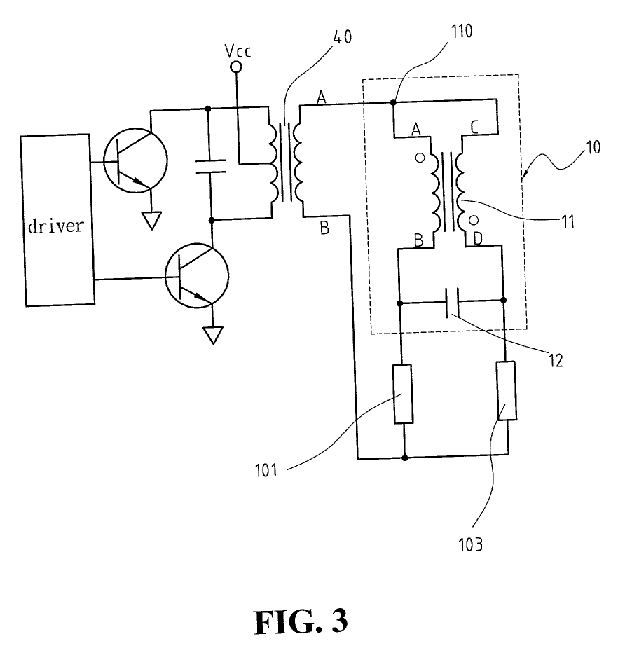

As illustrated in FIG. 3, in a first embodiment of a current equalizer assembly for LCD backlight panel of this invention, a current equalizer (10) is connected with two cold cathode fluorescent lamps (CCFLs) (101, 103). The current equalizer (10) is composed of a differential current choke (11) and a capacitor (12), in which the capacitor (12) strides on a terminal (B) of a primary coil and on a terminal (D) of a secondary coil of the differential current choke (11) such that a current flowing through those two CCFLs can lighten the CCFLs (101, 103) uniformly. The structure and circuit connections of this invention are to be described below.

A terminal (A) of the primary coil of the differential current choke (11) is connected to a terminal (C) of the secondary coil of the differential current choke (11) to form a common end (110), which is coupled to a terminal (A) of a secondary coil of a booster (40), and a common end of the CCFLs (101, 103) is connected with a terminal (B) of the secondary coil of the booster (40). Two ends of the capacitor 12 are jointed with other respective ends of the CCFLs (101, 103).

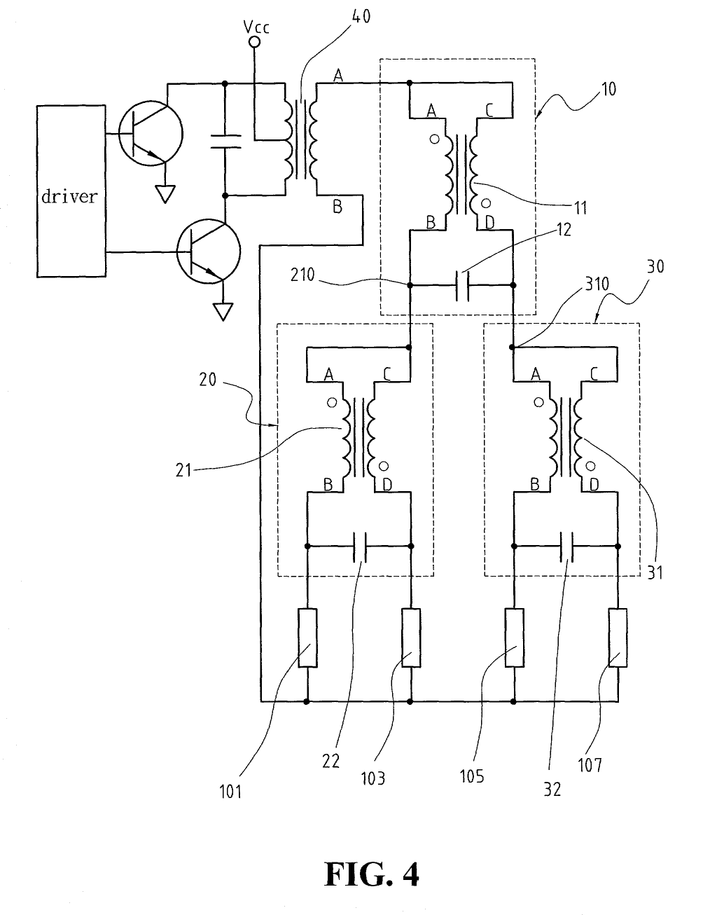

In a second embodiment shown in FIG. 4, three current equalizers (10, 20, 30) are connected with four CCFLs (101, 103, 105, 107). Two ends of a capacitor (22, 32) are coupled to one end of every two neighboring CCFLs (101, 103, 105, 107), meanwhile, a common end of those four CCFLs (101, 103, 105, 107) is connected with the terminal (B) of the secondary coil of the booster (40). Moreover, two ends of the capacitor (12) of the current equalizer (10) are coupled with respective common ends (210, 310) of the current equalizers (20, 30).

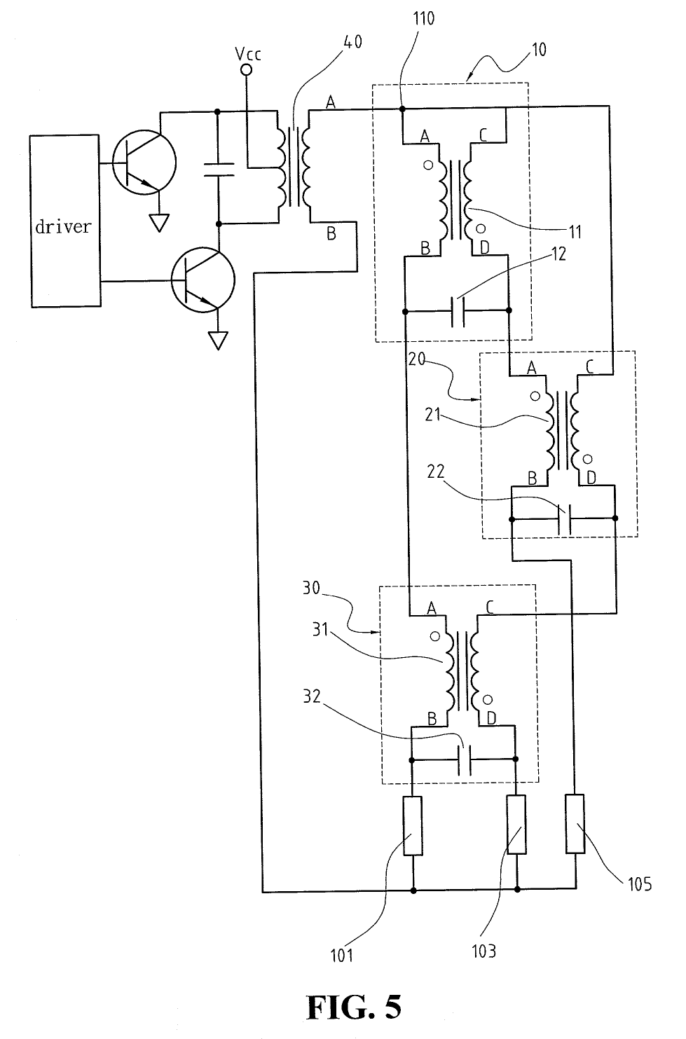

In a third embodiment shown in FIG. 5, three current equalizers (10, 20, 30) are connected with three CCFLs (101, 103, 105). Two ends of a capacitor (32) of the third current equalizer (30) are connected to one end of those two CCFLs (101, 103) respectively. One end of a capacitor (22) of the second current equalizer (20), (namely, a terminal (B) at a primary coil of a differential current choke (21) of the second current equalizer (20)), is jointed with one end of the third CCFL (105). Furthermore, a terminal (D) at a secondary coil of the differential current choke (21) of the second current equalizer (20) is connected to a terminal (C) at a secondary coil of a differential current choke (31) of the third current equalizer (30). In the differential current choke (11) of the first current equalizer (10), a terminal (A) at a primary coil and a terminal (C) at a secondary coil are jointed together to form a common end (110), which is connected to the terminal (A) at the secondary coil of the booster (40). Besides, two ends of a capacitor (12) of the first current equalizer (10) are connected to a terminal (A) at the primary coil of the differential current choke (21) of the second current equalizer (20) and a terminal (A) at a primary coil of the differential current choke (31) of the third current equalizer (30). Moreover, the other end of the CCFLs (101, 103, 105) are put together and coupled with a terminal (B) at a secondary coil of the booster (40).

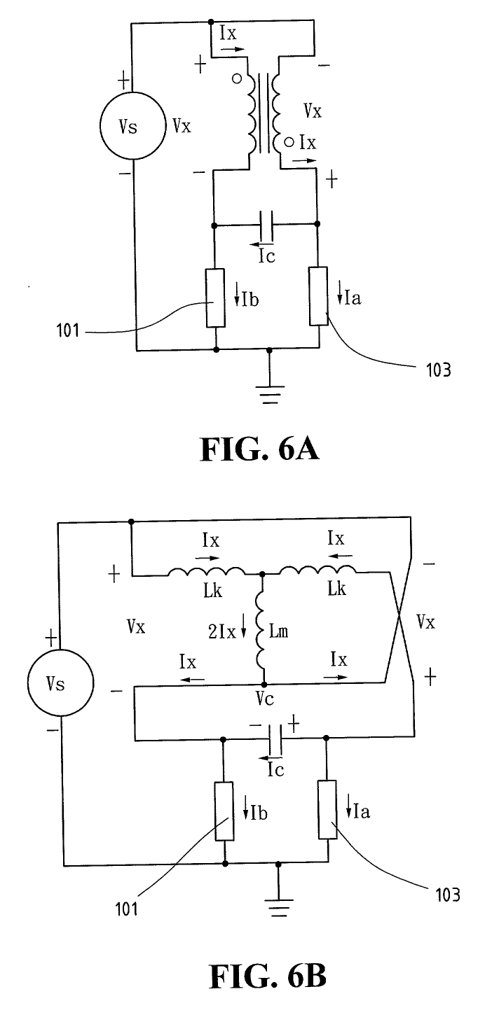

FIG. 6A shows the structure of a current equalizer of this invention, and FIG. 6B shows an equivalent circuit of FIG. 6A. In order to equalize the current flowing through those two CCFLs (101, 103) according to the circuitry principles of this invention, namely Ia=Ib, the voltage Vc across two terminals of a capacitor has to satisfy the following equation (1):

Vc=IaZa−IbZb=Io(Za−Zb)=2Vx (1)

where Ia=Ib=Io, Za and Zb represent impedance of the CCFLs (101, 103). An Ic passing through the capacitor is:

$$Ic = \frac{Vc}{Zc} = \frac{Vc}{\frac{1}{j ω C}} = j ω CVc = j ω C ( 2 Vx ) \qquad ( 2 )$$

For equalizing Ia and Ib, let L=Lm+Lk (mutual inductance and leakage inductance in a differential current choke) to obtain

$$Ix = \frac{Vx}{j ω L} \times \frac{1}{2} = - j ω C ( 2 Vx ) \qquad ( 3 )$$

Substitute 2πf for ω, we obtain

$${ω}^{2} = \frac{1}{4 L C}$$

$$or C = \frac{1}{16 {π}^{2} {Lf }^{2}}$$

All the embodiments of this invention are made in accordance with abovesaid circuitry principles. A core of UU.98 is wound by coated wires of 0.2 phi in 91 turns (Ts) on both sides to form a differential current choke (L=11.9 mH). The differential current choke(s) and capacitor(s) of 147 pf are adopted for mating with two CCFLs (TOSHIBA LCD PANEL (LTM15C151A)) and operated and tested at 60 KHz. As the current data obtained in those two CCFLs of conventional circuits shown in FIG. 2 are 6.42 ma and 9.53 ma respectively, while that of this invention shown in FIG. 3 are 8.47 ma and 8.52 ma, the current difference between CCFLs has been obviously and significantly reduced. In practical applications, the capacitance C might be included in the stray capacitance and is therefore negligible particularly when the inductance L is large enough.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A current equalizer assembly for LCD backlight panel, comprising at least a differential current choke and at least a capacitor, in which the capacitor is arranged striding on a terminal (B) at a primary coil and a terminal (D) at a secondary coil of the differential current choke so as to equalize the current flowing through cold cathode fluorescent lamps (CCFLs) connected to the differential current choke and balance the lightness thereof accordingly.

2. The current equalizer assembly according to claim 1, in which a terminal (A) at the primary coil of the differential current choke is connected with a terminal (C) at a secondary coil of the same to form a common end, which is coupled with a terminal (A) at a secondary coil of a booster; and one end of each of cold cathode fluorescent lamps are commonly jointed with a terminal (B) at the secondary coil of the booster.

3. The current equalizer assembly according to claim 2, being connected with two CCFLs, in which two ends of a capacitor are connected to the other respective ends of the CCFLs.

4. The current equalizer assembly according to claim 2, in which two capacitors of those two current equalizers are connected with the other ends of every two neighboring CCFLs, and two ends of a capacitor of a rest current equalizer are coupled with the common end of those two current equalizers.

5. The current equalizer assembly according to claim 1, in which two terminals of a capacitor of a third current equalizer are connected to one end of two CCFLs respectively; one terminal of a capacitor of a second current equalizer is jointed with one end of another CCFL, the other terminal of the capacitor is connected to a terminal (C) at a secondary coil of a differential current choke of the third current equalizer; in the differential current choke of the first current equalizer, a terminal (A) at a primary coil and a terminal (C) at a secondary coil are jointed together to form a common end, which is connected to the terminal (A) at the secondary coil of a booster; two ends of a capacitor of the first current equalizer are connected to a terminal (A) at the primary coil of the differential current choke of the second current equalizer and a terminal (A) at a primary coil of the differential current choke of the third current equalizer; and the other end of those three CCFLs are put together and coupled with a terminal (B) at a secondary coil of the booster.

6. The current equalizer assembly according to claim 1, in which the capacitance of the stridden capacitor is replaceable by the intrinsic stray capacitance when the inductance of the differential current choke is properly selected.
